(19) United States
(12) Patent Application Publication
(10) Pub. No.: US 2005/0240754 A1
(43) Pub. Date: Oct. 27, 2005

(54) Service interfaces

(75) Inventor: Otso Auterinen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/927,476

(22) Filed: Aug. 27, 2004

(30) Foreign Application Priority Data
Apr. 26, 2004 (GB) 0409301.9

(51) Int. Cl. G06F 7/00

(52) U.S. Cl. 713/1

(57) ABSTRACT

In a data communication system at least one content provider may be configured to serve clients based on data received from at least one content supplier. The data communication system is provided with an authenticator configured to maintain authentication information associated with the at least one content supplier and to authorise use of data received from the at least one content supplier. The arrangement is such that authentication information associated with the at least one content supplier is not revealed by the authenticator.

### BACKGROUND OF THE INVENTION

1. Field of the Invention

The present disclosure relates to a communication system, and in particular, but not exclusively, to controlling use of data in entities other than an entity which provided the data. Data may be received, for example, by a service provider application from a supplier who generates content data. The service provider may use the data in servicing clients via a communication system.

2. Description of the Related Art

A communication system can be seen as a facility that enables communication sessions between two or more entities such as user equipment and/or other nodes associated with the communication system. The communication may comprise, for example, communication of voice, data, multimedia or other content. A user equipment may, for example, be provided with a connection to an application providing entity, for example to an application server (AS), enabling use of services provided by the application server. For example, multimedia content, such as images, videos, audio files or other recordings, may be downloaded from the application server to the user equipment.

Users connected to a communication system may also send data to other entities, such as to an application server, via a communication system. For example, a user may create a work of art, such as take a photo or make a video, and send the work in a digitized form, i.e. as content data to an application server. The work may then be downloaded from the application server by other parties interested of the same subject.

If somebody wants to use the work for something else without infringing the rights of the creator of work, such a third party needs to obtain a consent from the creator of the work. For example, the willing user may need to negotiate a license, or other terms enabling use of the work. Even if the work itself can be communicated via a data communication system, such negotiations have been accomplished m conventional manner, for example face to face, over the phone, by, mail or by email. Such as negotiation process may be too heavy for enabling use of, for example, a one off photograph. Furthermore, a supplier of content data may wish to remain anonymous from the users of the data, such as the end user or service providers. In addition, in certain situation a secure system is needed for rewarding the creator of the work while keeping the financial and/or other data associated with the creator undisclosed from the users of the data. Furthermore, it might be desirable to be able to add value to content for example by annotating, re-arranging or otherwise in a collaborative manner while maintaining trust between individuals or within a group of individuals with a mutual trust.

### SUMMARY OF THE INVENTION

Embodiments of the present invention aim to address one or several of the above problems.

According to one embodiment of the invention, there is provided a data communication system comprising at least one content provider configured to serve clients based on data received from at least one content supplier. The system also comprises an authenticator configured to maintain authentication information associated with the at least one content supplier and to authorise use of data received from the at least one content supplier without revealing authentication information associated with the at least one content supplier.

According to another embodiment there is provided an authenticator for a data communication system comprising at least one content provider configured to serve clients via a the data communication system based on data received from at least one content supplier. The authenticator is configured to have a trusted relationship with at least one content provider and at least one content supplier. The authenticator comprises a data storage for maintaining authentication information associated with the at least one content supplier and an authorising processor for authorising use of data the at least one content provider has received from the at least one content supplier without revealing authentication information associated with the at least one content supplier.

According to another embodiment there is provided a method for controlling use of data. The method comprises the steps of providing an authenticator with information associated with the identity of a content supplier, receiving in a content provider data from the content supplier, and authorising by the authenticator the content provider to use data received from the content supplier. Content is then generated by the content provider based on the data received from the content supplier.

In further embodiments there is provided devices configured to operate in accordance with the present invention such as a content provider data processing arrangement configured to serve clients based on data received from at least one content supplier, a user equipment for a data communication system, and a control entity for a data communication system.

The embodiments of the invention may provide various advantages. The process of selling and/or obtaining rights to creations by content suppliers may be streamlined, and even made fully automatic. The supplier of data content may remain anonymous from users of the data. Usage data may be collected such that the users of the data do not become aware of the actual figures. Security and controllability of use of content data may be improved.

### BRIEF DESCRIPTION OF DRAWINGS

For better understanding of the present invention, reference will now be made by way of example to the accompanying drawings in which:

FIG. 1 shows one embodiment of the present invention;

FIG. 2 is a flowchart illustrating the operation of one embodiment of the present invention; and

FIGS. 3 and 4 show further embodiments.

### DETAILED DESCRIPTION OF THE PREFERRED EMBODIMENTS

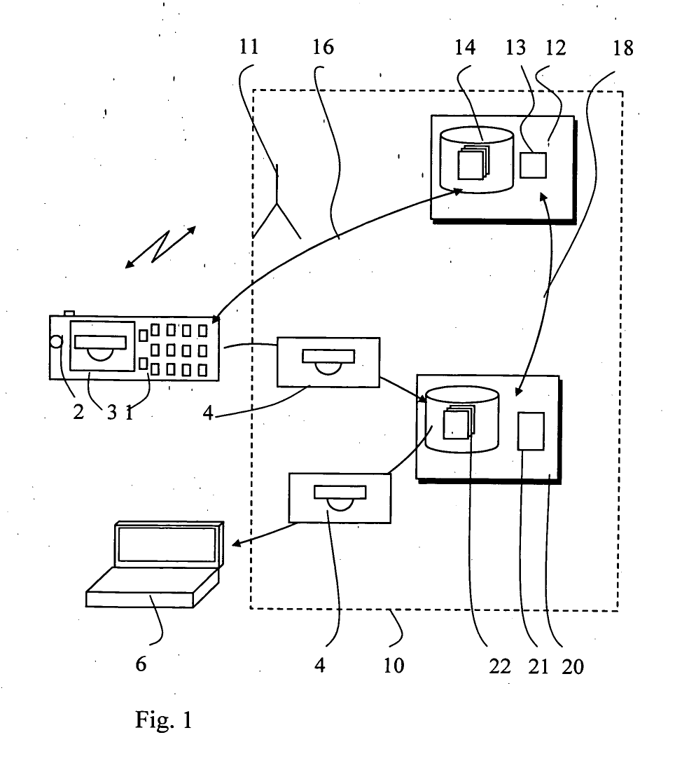

Certain embodiments of the present invention will be described in the following by way of example, with reference to an exemplifying communications system 10 of FIG. 1 enabling wireless communications. The communication system may be adapted for enabling Internet Protocol (IP) communications. The communication system 10 may then be used for offering IP multimedia services by means of appropriate service providers for users of user equipments 1 and 6 connected to the communication system 10. It shall be appreciated that the embodiments may be applied to any communication system suitable for communication of data. It shall also be appreciated that although only two user equipments 1 and 6 are shown in FIG. 1 for clarity, a great number of user equipments may communicate simultaneously via a communication system.

The exemplifying user equipment 6 is shown to be a laptop computer. The laptop computer 6 may be connected to the communication system 10 by means of a fixed connection or a wireless connection. The fixed connection may be an any appropriate connection such as a dial-up modem connection or an ‘always on’ connection, for example a broadband connection provided by means of an ISDN or ADSL subscription. A possible wireless connection between a user equipment and a communication system is exemplified in the following with reference to the user equipment 1.

User equipment 1 is shown to be connected to a base station 11 of the communication system 10 via a wireless interface, thus providing mobility for the user of the user equipment 1. Communication systems proving wireless communication for user equipment are known. An example of the wireless systems is the public land mobile network (PLMN). Another example is a mobile communication system that is based, at least partially, on use of communication satellites. Wireless communications may also be provided by means of other arrangements, such as by means of a wireless local area network (WLAN).

Communication on the wireless interface between the user equipment 1 and the elements of the communication system can be based on an appropriate communication protocol. The operation of the base station apparatus of the communication system and other apparatus required for the communication can be controlled by one or several control entities. The various control entities may be interconnected. One or more gateway nodes may also be provided for connecting a communication network to other networks. For example, in a communication system a mobile network may be connected to communication networks such as an IP (Internet Protocol) and/or other packet switched data networks.

The user equipment 1 of FIG. 1 may comprise any appropriate mobile user equipment adapted for Internet Protocol (IP) communication. For example, the mobile user may access the cellular network by means of a Personal computer (PC), Personal Data Assistant (PDA), mobile station (MS) and so on. The following example is described with reference to a mobile station.

One skilled in the art is familiar with the features and operation of a typical mobile station. Thus, it is sufficient to note that the user may use a mobile station for tasks such as for making and receiving phone calls, for receiving and sending data from and to a communication network and for experiencing content data, sending content data or otherwise using multimedia services. A mobile station may include an antenna for wirelessly receiving and transmitting signals from and to base stations of the mobile communication network or a local area network.

A mobile station may also be provided with a display 3 for displaying images and other graphical information for the user of the mobile user equipment. Speaker means are also typically provided. Camera means 2 may be provided for capturing still or video images. Other recording means may also be provided, for example for, generating audio data. The operation of a mobile station may be controlled by means of an appropriate user interface such as control buttons, voice commands and so on. Furthermore, a mobile station is commonly provided with an appropriate data processor entity and a memory means.

In FIG. 1, a work created by the user of the user equipment 1 comprises an image shown on the display 3 of the user equipment 1. The image may have been captured by the user using the camera means 2 of the user equipment. In the following example the image on the display 3 equals with the content data 4 send to a content provider.

In an embodiment the content provider is provided by means of a server comprising necessary data storage and processing means. The application server 20 may be operated by any appropriate provider of services wherein data may be received from users, and such data may then be used in providing services for other users. The application server 20 is configured to receive content data, such as image 4, supplied by user equipment connected to the communication system. The application server 20 includes a database 22 for storing data received from the suppliers of the data. A processor 21 for processing data is also provided. The application server 20 is also configured to communicate data from the data base thereof to clients. In FIG. 1 image data 4 is shown to be communicated to the user equipment 6.

FIG. 1 shows also an authenticator entity 12.

The authenticator entity may be provided by an authentication server 12 comprising a processor 13 for processing and a database 14 for storing information required for the purposes of authentication and authorization of use of data from suppliers of data. A trusted relationship is created between the user equipment 1 and the authenticator entity 12, as shown by the two headed arrow 16. The authenticator entity 12 is configured to maintain identity information associated with users who wish to supply content data to the communication system for use by application servers. The user of the user equipment 1 relies that his/hers identity will not be unnecessarily revealed for third parties by the authenticator entity 12.

The trust between the user equipment 1 and the authenticator server 12 may be based on negotiations between the user and the authenticator regarding the terms for the authentication service. The negotiations may take before any content data is sent to the application server, or even created. Alternatively, the user may provide identity information to the authenticator only just before an authorization is required by the application server. During the negotiations the authenticator server is provided with necessary user identity information and other information such as possible billing information, any specific terms on distribution of the content and so on. All this data is stored together with the identity information in the database 14.

Another trusted relationship 18 is shown to be provided between the authenticator 12 and the application server 20.

The authenticator 12 may identify data that is authorized for use by the application server 20 based on a unique identity. The identity may be assigned for a specific data item, or for all data from a particular supplier. This identity may then be communicated to the application server 20 and used in any subsequent communication between the application and authenticator servers. Use of identifiers associated with data rather than the user can be used to ensure that an authorization to use the data is provided for the application server 20 without revealing unnecessary information regarding the identity of the supplier of the data.

If an application server 20 needs to use data supplied by a user, it may send a request for authorization to use the data from the authenticator 12. The authenticator 12 has the authority either to allow or reject such request. This requires that the data can be identified in the request for authorization.

As an alternative to such a specific request for authorization, authorizations may be pushed from the authentication server 12 to appropriate application servers. The application server 20 may then store indications in association with data stored in databases thereof regarding the authorization status thereof. The authorization status may be updated by a new authorization message from the authenticator. The authorization messages may be send to a selected application server, or a plurality of selected application server, or even to all application servers in the communication system.

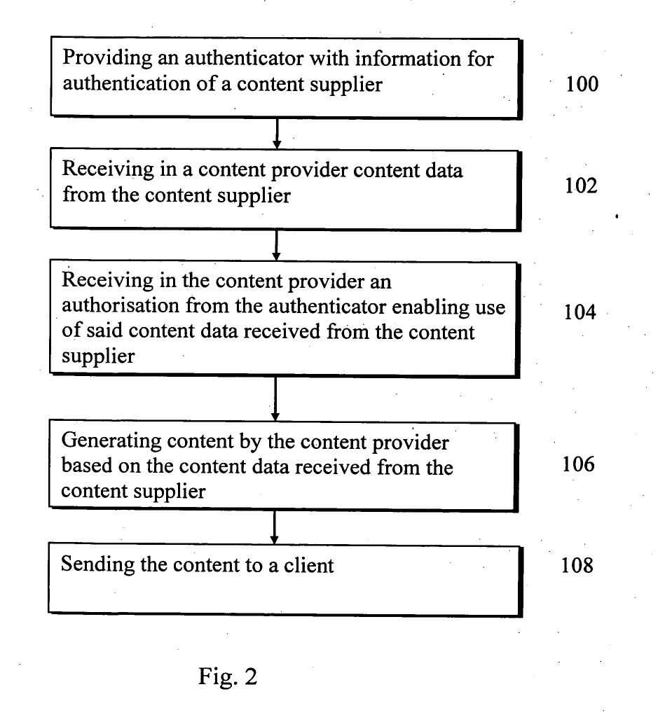

The operation in accordance with an embodiment is now briefly described with reference to the flow chart of FIG. 2. A user has content which he sends to an application server. At step 100 the user provides an authenticator with information that can be used for authentication of the content supplier. For example, the user may send identity information, a bank account number, or any other information that may be useful for identifying the user and/or for rewarding the user from the use of the data. The user may send the information his beforehand, at the time of sending content data to the application server, or later.

At step 102 the content provider receives content data from the user. At step 104 the content provider receives an authorisation from the authenticator enabling use of the content data received from the user. At step 106 the content provider may generate appropriate content from the content data received from the content data supplier.

The content sent to a client may be simply a copy of the data received from the content supplier. FIG. 1 illustrates this by showing an image data file 4 being send from user equipment 1 to the application server and then forwarded there from to user equipment 6. The forwarding of the image data file 4 occurs in step 108 of FIG. 2.

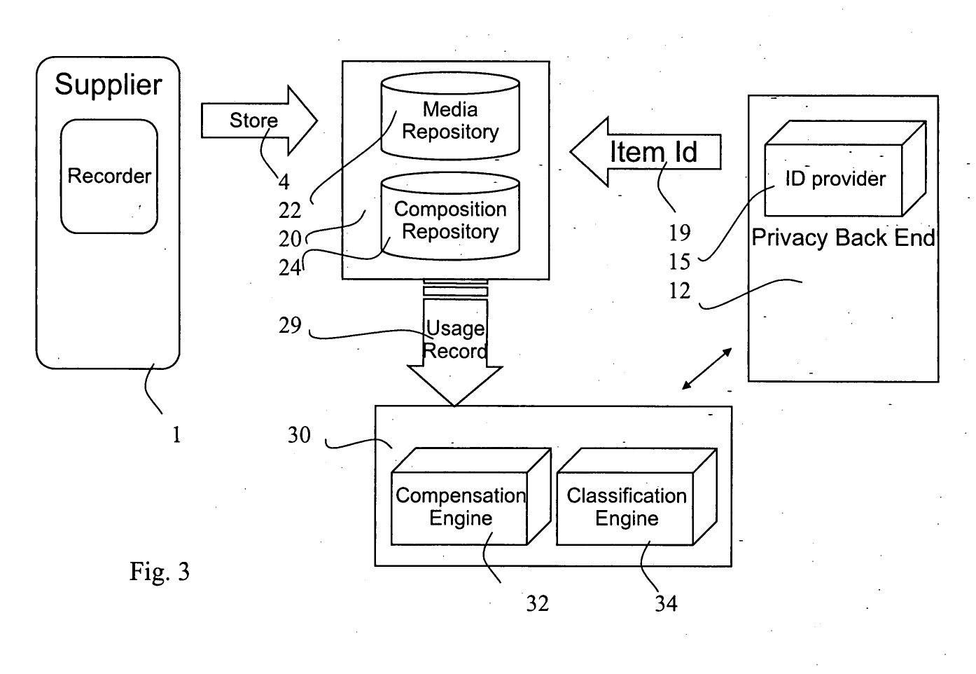

In an alternative embodiment the content provider combines content data received from at least one content data supplier to generate content which includes data from a number of content data files. Use of authorisations from the authenticator to form combined data is described below with reference to FIG. 3.

As above, the content data supplier 1 may store data in a data base 22 of a content data provider 20. However, instead of simply forwarding content data received from the suppliers, the content data provider 20 is configured to generate content based on data stored in the database 22, referred herein after as media repository. The composition engine 24 of the content provider 20 may then combine content data from a plurality of content suppliers for the purposes of serving a client. For example, the content provider may prepare a presentation containing images from a plurality of image data suppliers.

If data from a plurality of sources is to be combined, authorisation may be required for the use of content from at least two different suppliers for the combination. The authorisations may be based on identifiers, as explained above. For example, the authenticator 12 may send authorisation for each data item to the content provider 20. Each data item that is such authorised may then be used by the content provider. The authorisation may be done beforehand, on in response to a request by the content provider. C

An item ID may be generated by an authenticator, for example by means of a specific ID provider unit of an authenticator. A data entity, for example a special authorisation tag that is provided for use in authorisation may refer to an item ID.

The item ID can also be used later on to derive the identity of a supplier by the authenticator 12 or another entity authorised to receive the identity information. In FIG. 3 such entity is provided by a usage back end server 30. The usage back end server 30 may use usage records 29 provided by the content provider 20 for generating various information regarding the use of content data from the suppliers.

For example, a compensation engine 32 may be used for providing compensation for the suppliers of the data. The suppliers may be compensated in various manners, for example by means of a one-off payment or other license fee for the use of their content. The compensation may also be arranged such that the supplier receives a right to use other content for free from the content provider or from a specified other content provider. In principle, the compensation engine 32 may be configured to provide any type of compensation that may be felt appropriate by the users of the system and/or the service providers.

A classification engine 34 of the usage back end 30 may be used for providing statistical information regarding the use of the content data. For example, the classification engine may collect data regarding the desirability of various content classes and/or client behaviour.

The usage back end may receive information regarding the identities of the suppliers from the authenticator entity 12. This means that although the authenticator entity 12 sends information to a trusted usage back end, such information is not revealed to the content provider. Another possibility is that the usage back end sends processed data to the authenticator 12, which then takes care of the final compensation and other possible procedures. In the latter case the identity or other information remains within the authenticator 12.

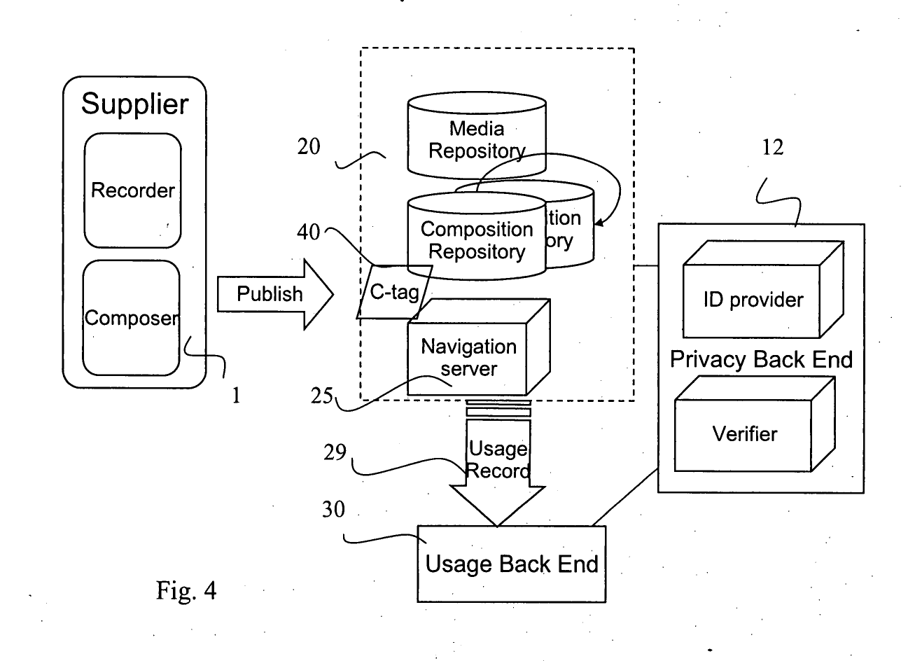

Some further embodiment will now be described with reference to FIG. 4.

In accordance with an embodiment a specific information element 40 for use in authorisation of data is created by a content provider 20. The information element 40 is configured to carry information that can be used to control use of media items by any content provider with a trust to a certifying authenticator. In brief, information element 40 may be configured to describe the rules-of-use of a media item. The information element 40 may be certified by an authenticator 12 selected by the supplier of the information element. A certified information element may then be used for authorisation purposes by any content provider with trust relationship to the authenticator without any further checks from the authenticator. Thus these information elements may be used to enable the content providers to ensure authorization of use of the data without a need to explicitly ask each time for authorization from the authenticators. The authorization may enable the content provider to use the data as such, or use the data in another context, for example as a part of a larger work, or even combine the data with other data and/or modify the data.

Certification of the information element 40 may allow a content provider to trust on the content of the element. A content provider may use the element for authorization based on the ability to interpret the contents of the information element (explicit authorization) or via interaction (implicit authentication) with the authenticator, which has certified the information element. Implicit authentication may be used for example if the authorization is based on a group membership managed by an authenticator.

The information element will be referred to in the following as a control tag, or C-tag. A C-tag may be associated with a data item by means of the identity of the data item (see Item ID of FIG. 3). A C-tag may thus be retrieved based on the Item Id of the designated item. Certification by an authenticator makes a C-tag suitable for copying between content providers with trust to a common authenticator.

A C-tag may define the rules of use for the item for example by defining who are allowed to know the existence, view and/or play a sample of the item or the item its entirety, use the item to construct other items, how compensation of usage is derived, how compensation should be paid, and so forth.

A content provider may operate based on a number of C-tags. A number of C-tags may associate with a media item for example when it is created by combining data items received from a number of suppliers. A first C-tag for a media item consisting of a number of data items may also be created by the supplier of a first data item. Such a C-tag may be called the root tag. Further C-tags may be created by other suppliers of data.

A supplier may associate new media items to an existing root tag. A shared root tag makes up a collection of media items to which equal authorization applies.

C-tags associated with content that is provided for a client may be certified by different authenticator entities.

The trust between an authenticator and a content provider may be revoked. All C-tags created by content provider and authority to certify C-tags on behalf of the authenticator are then also revoked.

FIG. 4 shows also a navigation server 25 associated with the content provider 20. The navigation server 25 may be provided for evaluating the potential of a user to navigate in media item space based on information about the user. For example, the navigation server may evaluate any group memberships of the user. Based on information passed by a privacy back end, i.e. the authenticator 12, the navigation server may identify such C-tags which authorize a user to know existence and execute actions to a data item. Thus the navigation server 25 may be used to assist a user to create data content from data stored in the databases of the content provider. A navigation server may maintain some kind of structure of data items. The navigator server may then project the common structure to users according to the authority of each individual user.

The data processing functions required for implementing embodiments may be provided by means of one or more data processor entities. Appropriately adapted computer program code product may be used for implementing the embodiments, when loaded to a computer, for example for performing required processing of content data. The program code product may be stored on and provided by means of a carrier medium such as a carrier disc, card or tape. A possibility is to download the program code product via a data network to an appropriate data processing entity.

The above described embodiments enable users of a communication system to share information without other users knowing any details, or all details regarding the supplier of the information. For example, a person may take a photo of an interest, say of an aeroplane, and supply that photo to a web site accessed by other enthuiasts. The supplier may give his/hers contact information so that willing third parties can get in contact with the owner of the rights to that photo in order to buy rights to use the photo e.g in a magazine. The emboidiments enable automatization of the negotiation part of the process, since the authenticator entioty may be authorised to sell the rights. The herein disclosed concept may also be used, for example, for hiding information associated with a party who supplies data to a service providing application from any other party associated with the service providing application. For example, a supplier of content may get paid from the content anonymously.

It should be appreciated that whilst embodiments of the present invention have been described in relation user equipment such as mobile stations and laptop computers, embodiments of the present invention are applicable to any other suitable type of user equipment capable of generating and/or presenting content data.

The embodiment of the present invention has been described in the context of a communication system providing wireless access for at least one of the users thereof. This invention is also applicable to communication system which do not enable wireless access.

It is also noted herein that while the above describes exemplifying embodiments of the invention, there are several variations and modifications which may be made to the disclosed solution without departing from the scope of the present invention as defined in the appended claims.

1. A data communication system, comprising:
at least one content provider configured to serve clients based on data received from at least one content supplier; and
an authenticator configured to maintain authentication information associated with the at least one content supplier and to authorise use of data received from the at least one content supplier without revealing authentication information associated with the at least one content supplier.

2. The communication system as claimed in claim 1, wherein the content provider is configured to combine data received from a plurality of content suppliers, and the authenticator is configured to authorise combining of data from the plurality the content suppliers.

3. The communication system as claimed in claim 1, further comprising a compensation entity operationally connected to the authenticator and configured to process data in order to provide the at least one content supplier with compensation for the use of data provided by the at least one content supplier.

4. The communication system as claimed in claim 1, comprising a usage data collector configured to associate usage data from the content provider with authentication information from the authenticator.

5. The communication system as claimed in claim 1, comprising a navigator entity associated with the content provider for evaluating the possibilities of using data from the at least one content supplier.

6. An authenticator for a data communication system comprising at least one content provider configured to serve clients via the data communication system based on data received from at least one content supplier, the authenticator being configured to have a trusted relationship with the at least one content provider and the at least one content supplier, comprising:
a data storage for maintaining authentication information associated with the at least one content supplier; and
an authorising processor for authorising use of data the at least one content provider has received from the at least one content supplier without revealing authentication information associated with the at least one content supplier.

7. A method for controlling use of data, comprising the steps of:
providing an authenticator with information associated with the identity of a content supplier;
receiving, in a content provider, data from the content supplier;
authorising, by the authenticator, the content provider to use data received from the content supplier; and
generating content, by the content provider, based on the data received from the content supplier.

8. The method as claimed in claim 7, comprising the further step of authorising combining of data received from a plurality of content suppliers.

9. The method as claimed in claim 7, comprising the further step of processing data in order to provide at least one content supplier with compensation for use of data provided by the at least one content supplier.

10. The method as claimed in claims 7, comprising sending an information element from the content supplier together with content data, the information element carrying information regarding allowable use of the content data.

11. A computer program embodied on a computer readable medium, said computer program comprising program code means configured, when the program is run on a computer, to perform any of steps of:
providing an authenticator with information associated with the identity of a content supplier;
receiving, in a content provider, data from the content supplier;
authorising, by the authenticator, the content provider to use data received from the content supplier; and
generating content, by the content provider, based on the data received from the content supplier.

12. A content provider data processing arrangement configured to serve clients based on data received from at least one content supplier, the arrangement comprising:
an interface for receiving content data from at least one content supplier;
an interface for receiving authorisation data from an authenticator configured to maintain authentication information associated with the at least one content supplier and to authorise use of data received from the at least one content supplier without revealing authentication information associated with the at least one content supplier; and
a processor configured to service clients based on content data received from the at least one content data supplier and authorisation data from the authenticator.

13. A user equipment for a data communication system comprising:
an interface for; sending content data to at least one content provider for use by the content provider in serving clients and for communicating authentication data with an authenticator of an authentication arrangement, wherein the authenticator has a trusted relationship with a user equipment and is authorised by the user equipment to authorise use of content data provided by the user equipment; and
a processor configured to send identity information associated with the user equipment only to the authenticator, whereby authentication information associated with the user equipment providing content data is hidden from the at least one content provider.

14. A control entity for a data communication system, the control entity comprising:
at least one data processor configured to associate usage data associated with at least one content data supplier and received from at least one content provider with authentication data received from an authenticator in an arrangement, wherein the authenticator is in trusted relationship with the user equipment and identity information associated with content data suppliers is hidden from content data providers.

15. An apparatus for controlling use of data, comprising:
providing means for providing an authenticator with information associated with the identity of a content supplier;
receiving means for receiving, in a content provider, data from the content supplier;
authorising means for authorising, by the authenticator, the content provider to use data received from the content supplier; and
generating means for generating content, by the content provider, based on the data received from the content supplier.
